(19) United States
(12) Patent Application Publication
(10) Pub. No.: US 2005/0191525 A1
(43) Pub. Date: Sep. 1, 2005

(54) Magnetic recording medium and magnetic recording medium substrate

(75) Inventors: Toshihiro Tsumori, Takefu-shi (JP); Yu Hamaguchi, Takefu-shi (JP)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Shin-Etsu Chemical Co., Ltd.

(21) Appl. No.: 11/063,154

(22) Filed: Feb. 22, 2005

(30) Foreign Application Priority Data
Feb. 27, 2004 (JP) 2004-054988

(51) Int. Cl. G11B 5/147; H01F 1/00

(52) U.S. Cl. 428/836; 428/848.8; 427/548

(57) ABSTRACT

A magnetic recording medium substrate has a diameter of not more than 90 mm and disposed thereon a soft magnetic film plating layer comprising an alloy that comprises at least two metals selected from the group consisting of Co, Ni and Fe. In a concentric circular direction within the substrate plane, a value of the coercive force obtained by a VSM magnetization measurement, is less than 30 oersteds, and a ratio of saturation magnetization to residual magnetization is from 50/1 to 5/1. Spike noise deterioration of signal reproduction caused by leaking magnetic fields is reduced in the soft magnetic layer.

### BACKGROUND OF THE INVENTION

1. Field of the Invention

The present invention relates to a magnetic recording medium substrate and to a magnetic recording medium comprising a recording layer.

2. Description of the Related Art

In the field of magnetic recording, hard disk devices have become indispensable as primary external recording devices of computers, for example personal computers, for recording information. As hard disk drive recording densities increase, development of perpendicular magnetic recording methods which allow higher recording densities is progressing, replacing conventional longitudinal magnetic recording methods.

In perpendicular magnetic recording, the magnetic field from an adjacent bit points in the same direction as the magnetization direction, forming a closed magnetic circuit between two adjacent bits. The self-reducing magnetic fields (referred to below as “demagnetizing fields”) caused by the bits' own magnetization are less than in horizontal magnetic recording, leading to more stable magnetization conditions.

In perpendicular magnetic recording there is no particular necessity to make the magnetic film thin with increases in recording density. In this respect, the perpendicular magnetic recording can reduce the demagnetizing field and secure the KuV value, wherein Ku represents anisotropic energy, particularly crystalline magnetic anisotropic energy in the case of magnetic recording, and V represents a unit recording bit volume. Accordingly, it is robust against magnetization by thermal fluctuations, and it can be said to be a recording method that makes it possible to push the recording limit significantly upward. As recording media, perpendicular recording media have a high affinity with horizontal recording media, and it is possible to use basically the same technology as was used conventionally in both reading and writing of magnetic recording.

As for perpendicular magnetic recording media, there has been extensive research in double-layered perpendicular magnetic recording media, which comprise a soft magnetic lining layer (typically permalloy or the like), a recording layer (for which candidate materials include CoCr-based alloy, SmCo amorphous film and multi-layer film of alternating laminated layers of a PtCo layer and ultra-thin films of Pd and Co), a protective layer and a lubricating layer, layered in this order on a substrate.

Double-layered perpendicular magnetic recording media have much better writing properties than perpendicular magnetic recording media that have only a recording layer as their magnetic functional layer.

It is necessary that the lining layer of the double-layered perpendicular magnetic recording medium is soft magnetic, and that it has a film thickness in the region of about 100 nm to about 500 nm. As well as serving as the path for magnetic flux from the recording film on or above it, the soft magnetic lining layer also serves as the path for the writing flux from the recording head. Thus, it has the same function as an iron yoke in the magnetic circuit of a permanent magnet so that it is required to be much thicker than the recording layer.

Compared to film formation of a non-magnetic Cr-based primer layer in a horizontal recording medium, it is not a simple matter to form the soft magnetic lining layer of a double-layered perpendicular recording medium. Ordinarily, the layers constituting a horizontal recording medium are all formed by a dry process (mainly by magnetron sputtering) (see Japanese Patent Application Unexamined Publication No. 5-143972/1993). Methods for forming not only the recording layer but also the soft magnetic layer by dry processing have been investigated for double-layered perpendicular recording media as well. However, with regard to mass-production and productivity, there are large problems with fabricating soft magnetic layers by dry processing because of process stability, the complexity of parameter settings, and more than anything else, process speed. Furthermore, for the purpose of achieving higher densities, it is necessary to make the height at which the head floats above the surface of the magnetic disk (the flying height) as low as possible and in the manufacture of the double-layered perpendicular magnetic recording medium, it is necessary to cover the substrate with a metal film of such a thickness that it can be leveled by grinding. However, because the adhesion of thick films obtained by a dry process is low, leveling by grinding is very problematic. Thus, various tests were performed to cover a non-magnetic substrate with a metal film by plating methods, with which thick films can be formed more easily than by vacuum deposition.

### SUMMARY OF THE INVENTION

If a soft magnetic layer for a double-layered type perpendicular magnetic recording medium is film formed by plating, then many magnetic domains which are magnetized in a specific direction are created in a range of several millimeters to several centimeters on the plating film surface that constitutes the soft magnetic layer, and magnetic domain walls are generated at the boundaries of these magnetic domains. If a soft magnetic layer containing such magnetic domain walls is used in double layer perpendicular magnetic recording media, then there is the problem of a large deterioration of signal reproduction characteristics due to the generation of isolated pulse noise known as spike noise, caused through leaking magnetic fields generated by the magnetic domain wall portions.

In order to obtain, by a simple method, a double-layered perpendicular magnetic recording medium that has excellent properties, the inventors of the present invention have thoroughly investigated conditions for forming soft magnetic layers by plating, and the types of soft magnetic layers that are applicable.

As a result, it was found that when forming a soft magnetic layer on a substrate for a recording medium through electroless plating using an alloy that comprises at least two metals selected from Co, Ni and Fe, if the soft magnetic layer has a coercive force of less than 30 oersteds (Oe), as measured by a VSM, in a direction that is parallel to the soft magnetic layer and a ratio of the saturation magnetization to the residual magnetization is in a range of 50/1 to 5/1, then this is exceedingly effective in deterring the occurrence of spike noise, and the magnetic domain walls that cause it. The inventors further performed a detailed investigation of the plating conditions in order to attain such a soft magnetic layer, and found that it is advantageous if plating is performed while applying a parallel magnetic field of 100 to 800 oersteds in a direction parallel to the plated substrate during the electroless plating, and to let the plated substrate rotate and revolve in such a manner that the ratio of the rate at which the film is plated onto the substrate to the plating solution rate at the surface of the substrate to be plated is 1/3,000 or smaller and larger than 1/200,000, thus arriving at the present invention.

That is to say, the present invention provides a magnetic recording medium substrate comprising:

a substrate having a diameter of not more than 90 mm and

a soft magnetic film plating layer comprising an alloy that comprises at least two metals selected from the group consisting of Co, Ni and Fe, which is provided on the substrate,

wherein, with respect to a concentric circular direction within the substrate plane, a value of the coercive force obtained by a VSM (vibrating sample magnetometer) magnetization measurement is less than 30 oersteds, and a ratio of the saturation magnetization to the residual magnetization is from 50/1 to 5/1.

Moreover, the present invention provides a method for manufacturing a magnetic recording medium substrate, the method comprising:

a step of forming a primer plating layer on a substrate having a diameter of not more than 90 mm by immersing the substrate in a plating solution containing a metal ion of at least one metal selected from the group consisting of Ag, Co, Cu, Ni, Pd and Pt; and

a step of forming, by electroless plating, a soft magnetic layer on the primer plating layer by immersing the substrate on which the primer plating layer has been formed in a plating solution containing metal ions of at least two metals selected from the group consisting of Co, Ni and Fe;

wherein in the step of forming the soft magnetic layer, electroless plating is used, the plating is performed while applying a parallel magnetic field of 100 to 800 oersteds in a direction parallel to the plated substrate, and the substrate is covered while being rotated and/or revolved during the plating such that a ratio of a rate at which the film is plated onto the substrate to a plating solution rate at the surface of the substrate to be plated is 1/3,000 or smaller and larger than 1/200,000, under the condition that the plating speed is at least 0.03 μm/min and less than 0.3 μm/min.

The present invention further provides a magnetic recording medium using such a substrate.

In accordance with the present invention, the magnetic recording medium and the magnetic recording medium substrate to which the soft magnetic plating is applied have a very low occurrence of magnetic domain walls on their surface, and excellent spike noise characteristics. By using this in perpendicular magnetic recording devices, excellent noise characteristics, that is, high recording densities can be achieved. In addition, in the present invention, the soft magnetic layer is formed by wet electroless displacement plating so that the process is simpler and far more productive than introducing a primer layer by such methods as vapor deposition. Moreover, this process for manufacturing the soft magnetic layer can ensure smoothness by polishing after plating, and the resulting magnetic recording medium has excellent characteristics.

### BRIEF DESCRIPTION OF THE DRAWINGS

FIG. 1 is a diagram showing an inflection point in a minor loop.

FIG. 2 is a diagram showing the direction in which a magnetic field is applied during plating when forming the soft magnetic film.

FIG. 3 is a diagram showing a circumferential minor loop and a radial minor loop (Example 1).

FIG. 4 is a diagram showing a circumferential minor loop and a perpendicular minor loop (Example 1).

FIG. 5 is a diagram showing a reproduction envelope pattern (Example 1).

FIG. 6 is a diagram showing an image taken with a magnetic sensor device (Example 1).

FIG. 7 is a diagram showing an MFM image (Example 1).

FIG. 8 is a diagram showing an MFM image (Comparative Example 1).

### DETAILED DESCRIPTION OF THE PREFERRED EMBODIMENTS

As the substrate used in the present invention, it is preferable to use an aluminum substrate that has been subjected to Ni—P electroless plating, a glass substrate or a Si substrates of Si monocrystal, as conventionally used in the manufacture of magnetic recording media.

The Si monocrystal substrate is capable of being displacement-plated. Because it has exceedingly uniform properties, it may be particularly suited to accomplishing the object of the present invention with regard to suppressing magnetic irregularities caused by plating irregularities.

As for the Si monocrystal usable in the Si substrate, it is particularly preferable if the Si monocrystalline material is manufactured by the CZ (Czochralski) process or the FZ (Floating Zone) method. As for the surface orientation of the substrate, any orientation is possible, such as (1 0 0) , (1 1 0) or (1 1 1). Furthermore, it is also possible to comprise elements such as B, P, N, As and Sn as impurities in the substrate, at a total amount in the range of 0 to 10²² atoms/cm². However, when polycrystalline Si having different crystal orientations on the same substrate surface, and Si containing excessively dislocated impurities are used as a substrate, then the primer plating layer which is formed may be non-uniform because of differences in chemical reactivity. Moreover, if substrates having extreme dislocation are used, it may become impossible to achieve the primer plating layer structure as described in the present invention because a local battery is formed at the located portion of the substrate surface during formation of the primer plating layer.

When Si is used as the substrate material of the present invention, the necessary activation for primer plating layer formation can be performed by slightly etching the surface oxide film and the substrate surface. The method of etching can be selected from various methods such as acid, alkali and electrolytic etchings. With regard to the etching condition, when an aqueous alkali solution such as caustic soda is elected, etching can be done at a concentration of 2 to 60 wt % in a solution at 30 to 100° C. Then, the surface oxide film is removed and the substrate surface is slightly corroded so that displacement plating for obtaining good adhesion followed by electroless plating of the soft magnetic layer are carried out in this turn.

In the primer plating (displacement plating) after the etching process, a primer plating layer is obtained by immersing the substrate in a plating solution containing a metal ion of at least one metal selected from the group consisting of Ag, Co, Cu, Ni, Pd and Pt. The plating solution may have a concentration of the metal element(s) which is (are) metal ion(s) or principal metal ion(s), of at least 0.01 N, preferably of 0.05 to 0.3 N. It should be noted that in the case of a Si substrate, a primer plating layer is formed in which Si atoms at the substrate surface are substituted with metal atoms. The thickness of the displacement plating layer is preferably 10 to 1000 nm, more preferably 50 to 500 nm. If the layer is less than 10 nm thick, then a uniform distribution of the metal polycrystalline particles in the layer may not be obtained. If it is over 1000 nm thick, the individual crystalline particles may swell and may not be suitable as a primer layer.

In accordance with the present invention, when manufacturing a magnetic recording medium, a medium substrate is used in which, with respect to a concentric circular direction within the substrate plane, a value of the coercive force as obtained by a VSM magnetization measurement is less than 30 Oersted, and a ratio of saturation magnetization to residual magnetization is 50:1 to 5:1.

When Hₜᵣ is the value of an external magnetic field at the inflection point in the first quadrant of a minor loop of radial direction within the substrate plane and H_{tc}. is the value of an external magnetic field at the inflection point in the first quadrant of a minor loop of circumferential direction within the substrate plane, then it is preferable that the value of Hₜᵣ/H_{tc} is from 5 to 1.

It is preferable to use a substrate on which a plated soft magnetic layer having magnetic anisotropy in a circumferential in-plane direction is formed, so that the value of Hₜᵥ/H_{tc} becomes 10,000 to 100, wherein Hₜᵥ is the value of the external magnetic field at the inflection point in the first quadrant of a minor loop of the direction perpendicular to the substrate. Such a soft magnetic layer is particularly preferable in that magnetic domain walls and spike noise can be suppressed even better.

According to the above-noted VSM magnetization measurement, samples of 3 to 5 mm square are cut out, and magnetization amount and minor loop shape are measured with a vibrating sample magnetometer.

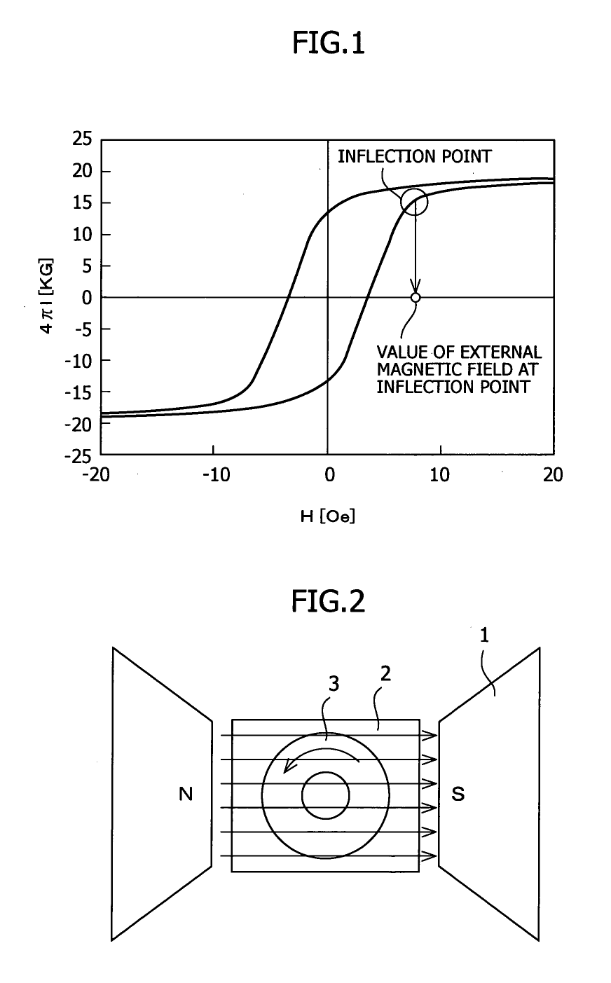

The inflection point of the first quadrant refers to the value of the external magnetic field at which the value of the first quadrant of the minor loop obtained by the above measurement is differentiated twice with respect to the measured external magnetic field H to yield a maximum, as shown in FIG. 1 for example. Actually, the first quadrant minor loop has two inflection points, namely one when the measurement magnetic field is increased and one when the measurement magnetic field is decreased. However, in the present invention, the inflection point for an increasing magnetic field, that is, the inflection point for the loop having the smaller measurement magnetization in the actual loops is thought of as the “inflection point in the first quadrant.”

It is preferable that the soft magnetic layer according to the present invention has a circumferential magnetic anisotropy, at which the value of Hₜᵣ/H_{tc} is from 5 to 1, wherein Hₜᵣ is the value of the external magnetic field at the inflection point in the first quadrant of a minor loop of a radial direction within the substrate plane and H_{tc} is the value of the external magnetic field at the inflection point in the first quadrant of a minor loop of a circumferential direction within the substrate plane. Although a soft magnetic film having such a circumferential magnetic anisotropy can be conjectured in theory, actual manufacture of the film with conventional sputtering or plating technology is difficult because of difficulty in obtaining such a magnetic state. According to the present invention, however, this magnetic state can be realized and optimum numerical values for application to magnetic recording media can be found so that superior characteristics can be ensured. By applying a circumferential magnetic anisotropy such that the value of Hₜᵣ/H_{tc} is from 5 to 1, it is possible to effectively suppress noise generated by the soft magnetic layer, for example.

It is preferable that the soft magnetic layer of the present invention has an in-plane magnetic anisotropy, such that the value of Hₜᵥ/H_{tc} becomes from 100,000 to 100 wherein Hₜᵥ is the value of the external magnetic field at the inflection point in the first quadrant of a minor loop of the direction perpendicular to the substrate. This magnetic anisotropy is unattainable through ordinary sputtering that is used in conventional methods for forming soft magnetic films. Accordingly, there is no way to foresee the effect for the case that such a soft magnetic layer is applied to a magnetic recording medium.

In the soft magnetic plating layer formation, a film can be formed by a method that is ordinarily known as electroless displacement plating. In electroless plating, it is possible to use a sulfide bath or a chloride bath, and it is possible to use various kinds of metals in the bath. However, in view of the need to realize the magnetic properties of the soft magnetic layer and to obtain a cubic crystal, it is preferable to use a metal salt containing element selected from Co, Ni and Fe, and to form an alloy plated layer containing at least two of these elements.

Co, Ni and Fe are suitable for electroless plating, and have superior properties as soft magnetic materials. Accordingly, in view of attaining the object of the present invention, it is preferable that these elements are contained. It is presumed that the magnetic properties of the present invention are caused by the location or segregation of the principal metal components in extremely small regions, so that it is necessary that the alloy plating layer contains at least two of these metal components. By contrast, it is difficult to attain the effect of the present invention with a plating layer of only a single metal.

The specific bath composition comprise at least two metal ions selected from nickel, cobalt and iron, and may include a mixed bath of nickel sulfate and cobalt sulfate or a mixed bath further containing iron sulfate. A preferable concentration in this case may be 0.01 to 0.5 N.

As the reducing agent for the electroless plating, it is possible to use any of a number of reducing agents, such as hypophosphorous acid or dimethylamine borane, depending on the bath and the metal ions constituting the bath.

The plated soft magnetic layer required by the present invention can be obtained by letting the substrate rotate and/or revolve during the plating such that the ratio of the rate at which the film is plated onto the substrate to the plating solution rate at the surface of the substrate to be plated is 1/3,000 or less and 1/200,000 or higher, preferably 1/8,000 or less and 1/150,000 or higher, while applying a parallel magnetic field of 100 to 800 oersteds in a direction parallel to the substrate surface when performing electroless plating.

During this, the plating film forming rate can be an important factor in realizing the present invention in the same manner as the above-noted ratio. The plating film forming rate can be at least 0.03 μm/min and less than 0.3 μm/min, preferably at least 0.2 μm/min. If the plating film forming speed is less than 0.03 μm/min, then it is difficult to attain a coercive force of less than 30 oersteds, regardless of the composition and the plating conditions. Moreover, the residual magnetization becomes too large, so that the ratio of the saturation magnetization to the residual magnetization in the direction perpendicular to the substrate surface becomes smaller than 5/1 which is necessary to accomplish the present invention. If the plating film forming speed exceeds 0.3 μm/min, then the crystal particles become amorphous, so that the residual magnetization becomes too small. Consequently, the ratio of the saturation magnetization to the residual magnetization in the direction perpendicular to the substrate surface becomes larger than 50/1 which is necessary to accomplish the present invention. Thus, it is not preferable.

If the ratio of the rate at which the film is plated onto the substrate to the plating solution rate at the surface of the substrate to be plated is larger than 1/3,000, then, there may be unpreferable cases where the Hₜᵣ/H_{tc} value is smaller than 1/1, wherein Hₜᵣ is the value of the external magnetic field at the inflection point in the first quadrant of a minor loop of a radial direction within the substrate plane and H_{tc} is the value of the external magnetic field at the inflection point in the first quadrant of a minor loop of a circumferential direction within the substrate plane. If the ratio of the plating film forming rate onto the substrate to the plating solution rate on the surface of the substrate to be plated is smaller than 1/200,000, the ratio of Hₜᵣ to H_{tc} becomes higher than 5/1 which is preferred by the present invention, and the unevenness of plating is generated. Thus, it is not preferable.

A method for obtaining a predetermined plating solution flow rate can be considered to include a method of controlling solution recirculation during plating, a method of stirring the plating solution using an agitator such as a paddle, or a method of rotating and/or revolving the substrate. Of these, the method of rotating and/or revolving the substrate is simple and effective for obtaining a predetermined solution flow rate. However, when the substrate has a large diameter, the substrate surface may be susceptible to eddy formation.

The size of the substrate according to the present invention is set to not more than 90 mm because of the difficulty of forming a uniform plating solution flow at the substrate surface when the size are larger than this, which makes it difficult to carry out the present invention.

The plating film forming rate in the present invention is defined as the grown thickness of the plating film per unit time. The plating film cross section can be examined with a scanning electron microscope or fluorescent X-ray analysis or the like.

What is referred to in this specification as “plating solution rate” is the rate of the plating solution in a direction parallel to the surface of the substrate to be plated, relative to the substrate. In particular, it is the rate of the plating solution in a region of less than 10 mm away from the substrate surface, relative to the substrate. The rate can be measured as a rate difference between the plating solution flow rate in the region and the substrate to be plated, using a pitot tube flow meter, a vane-wheel type mass flow meter, an ultrasound flow meter, or a laser-doppler flow meter.

In the region that is less than 1 mm away from the substrate to be plated, there is a stationary fluid layer of plating solution that moves in a state that is half fixed to the plating surface due to the viscosity, which is called the fluid boundary film. However, the plating solution flow rate of the present invention does not take into account the flow rate of portions directly adjacent to the substrate whose numerical measurement is difficult, like the fluid boundary film region.

What is referred to in this specification as “magnetic field in a direction parallel to the substrate surface” is a magnetic field that is applied such that the absolute value of the angle formed by the plated surface (i.e. the substrate plane) and the magnetic flux at any position of the substrate surface is less than 20°, and can be attained by placing permanent magnets or electromagnets 1 with respect to the substrate 3 in the plating solution 2 as shown in FIG. 2. When the strength of the magnetic field during plating is at least 100 oersteds and less than 800 oersteds, it may be different at different locations of the substrate, but the strength of the magnetic field should fall into this range at any location of the plated substrate surface.

If there is a location at which the strength of the magnetic field is less than 100 oersteds, then a portion or all portions of the soft magnetic layer on the substrate may not attain the magnetic properties that are an object of the present invention. When such a substrate is used to fabricate a magnetic recording medium, this may result in the generation of noise. On the other hand, if the value of the magnetic field exceeds 800 oersteds, then the covering power of the plating is reduced, and there may be variations in the alloy composition constituting the soft magnetic layer, which is undesirable.

A magnetic recording medium according to the present invention can be realized by forming the above-described soft magnetic layer of 100 to 1000 nm thickness, then forming a magnetic recording layer of 5 to 100 nm thickness on or above that layer, and preferably forming a protective layer of 2 to 20 nm thickness and/or a lubricating layer of 2 to 20 nm thickness, in that order.

If the thickness of the soft magnetic layer exceeds 1000 nm, then, when used as a recording medium, the magnetic noise from the soft magnetic layer during signal reproduction may become large, and the S/N ratio of the medium may lead to a reduction in characteristics, which is undesirable. On the other hand, if the thickness is less than 100 nm, then the magnetic permeation characteristics may be insufficient for a soft magnetic primer layer, and when used as a recording medium, there may be a reduction in overwrite characteristics, which is undesirable.

The magnetic recording layer on the soft magnetic layer is of hard magnetic material for the purpose of magnetic recording.

The magnetic recording layer can be formed directly on the soft magnetic layer, or it can be formed via one or more various intermediate layers such as Ti, by which crystal particle radius and magnetic characteristics can be matched as necessary.

There is no particular limitation to the material for the magnetic recording layer, as long as it is hard magnetic material containing magnetic domains that are easily magnetized in a direction perpendicular to the layer plane. It is possible to use various film such as a Co—Cr alloy film (e.g. Co—Cr—Ta, Co—Cr—Pt, Co—Cr—Ta—Pt) by sputtering, an Fe—Pt alloy film, a Co—Si granule film, or a Co/Pd multi-layered film. Furthermore, the film formed by wet plating can be used as the recording layer. The example of the recoding layer may include a Co—Ni based plating film and a coated film of barium ferrite of a magnetoplumbite phase.

The thickness of this type of recording layer may be preferably about 5 to 100 nm, more preferably 10 to 50 nm. The coercive force may be preferably 0.5 to 10 KOe, more preferably 1.5 to 3.5 KOe.

An example of the protective layer that is formed on the magnetic recording layer can include an amorphous carbon-based protective film formed through sputtering or CVD, and a protective film of crystalline Al₂O₃.

Furthermore, an example of the lubricating film of the uppermost layer may include a monomolecular film formed by application of a fluorine-based oil, and there is no particular limitation to the type of agent or method of the application.

The present invention is explained below with examples, however the present invention is not limited to these.

### EXAMPLE 1

Both surfaces of a (1 0 0) Si monocrystal (a P-doped N-type substrate) having a diameter of 65 mm, which had been produced by cutout, edge-removal and lapping of a Si monocrystalline substrate having a diameter of 200 mm fabricated by the CZ (Czochralski) method, were polished by colloidal silica having a mean particle size of 15 nm so as to have a mean square surface roughness (Rms) of 4 nm. The Rms is a measure of mean square roughness and was measured using an AFM (Atomic Force Microscope).

Being immersed for 3 minutes in a 2 wt % aqueous caustic soda solution at 45° C., the thin surface oxide film was removed from the surface of the substrate and then the Si surface was etched.

Then, a primer plating bath (solution) was prepared by adding 0.5 N ammonium sulfate into an aqueous solution of 0.1 N nickel sulfate and the substrate was immersed for 5 minutes in the bath heated to 80° C. so that the primer plating layer was formed.

Furthermore, a plating bath (solution) containing 0.2 N ammonium sulfate, 0.02 N nickel sulfate, 0.1 N cobalt sulfate, 0.01 N iron sulfate, and 0.04 N dimethyl amine borane as a reducing agent was prepared. The bath was heated to 65° C., such that the film growth rate of the electroless plating was 0.1 μm/min. Permanent magnets were arranged in front of and behind the plating bath, and a parallel magnetic field of 450 to 600 oersteds was applied to the substrate during the plating. The substrate to be plated was rotated at a rotation rate of 60 rpm, while electroless plating was performed for 20 min, yielding a soft magnetic layer of 2 μm thickness. During this time, the rate of the plating solution at a position 5 mm away from the substrate surface was measured by a laser doppler flow rate meter. The rate was measured to be 3000 mm/min with respect to the substrate at a radial position of 20 mm, i.e. at the inner circumference of the substrate. The rate was measured to be 10000 mm/min with respect to the substrate at a radial position of 32.5 mm, i.e. at the outer circumference of the substrate. Thus the ratios of the plating film forming rate to the plating solution flow rate at the substrate surface to be plated were 1/30,000 and 1/100,000, respectively.

When the magnetic characteristics of the soft magnetic film obtained in such a manner were measured using an vibrating sample magnetometer, the circumferential coercive force in the direction parallel to the face of the soft magnetic layer was 1 oersted, the saturation magnetization was 18 kG, and the residual magnetization was 1 kG, so that the ratio of saturation magnetization to residual magnetization was 18:1.

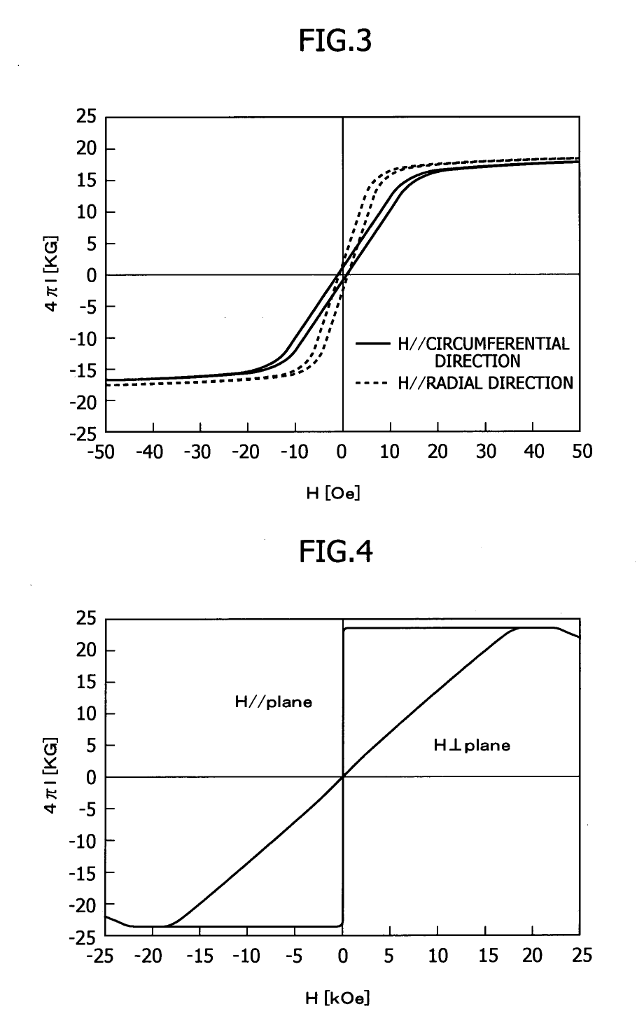

Furthermore, when Hₜᵣ and H_{tc} were measured on basis of a VSM magnetization measurement wherein Hₜᵣ is the value of an external magnetic field at the inflection point in the first quadrant of a minor loop of radial direction within the substrate plane and H_{tc} is the value of an external magnetic field at the inflection point in the first quadrant of a minor loop of circumferential direction within the substrate plane (see FIG. 3), Hₜᵣ and H_{tc} were found to be 13 oersteds and 8 oersteds, respectively. Thus, Hₜᵣ/H_{tc} was 1.63.

Furthermore, when Hₜᵥ was measured on basis of a VSM magnetization measurement wherein Hₜᵥ is an external magnetic field at the inflection point in the first quadrant of a minor loop of perpendicular direction (see FIG. 4), Hₜᵥ was found to be 1800 oersteds. Thus, Hₜᵥ/H_{tc} was 225. Hence, it was confirmed that a soft magnetic layer in accordance with the present invention had been formed.

After forming this soft magnetic layer, the substrate was covered with a perpendicular magnetic recording film of 20 nm thickness by sputtering with a composition of Co:Cr:Ta=79:19:2 (ratio in wt %), while maintaining the temperature at 220° C. When the coercive force of the recording layer was measured, the coercive force in the direction perpendicular to the film surface was 2.2 KOe and the coercive force in the direction parallel to the film surface was 500 oersteds.

Moreover, the substrate was covered with amorphous carbon of a thickness of 10 nm, and a fluorine-based lubricating film was applied by dipping thereon, thus obtaining a perpendicular magnetic recording medium.

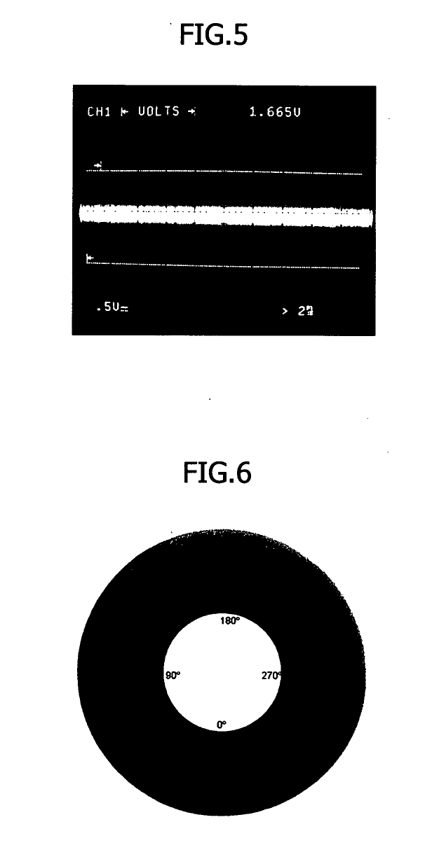

The resulting medium was installed on a spinstand and DC erasing was carried out. Then, a writing operation was performed with a nanoslider GMR head at a floating height of 10 nm and the reproduction signal was measured. The result of this measurement was that no spike noise was observed in the envelope pattern, as shown in FIG. 5. Also, the average level of the S/N ratio was an excellent 21 dB.

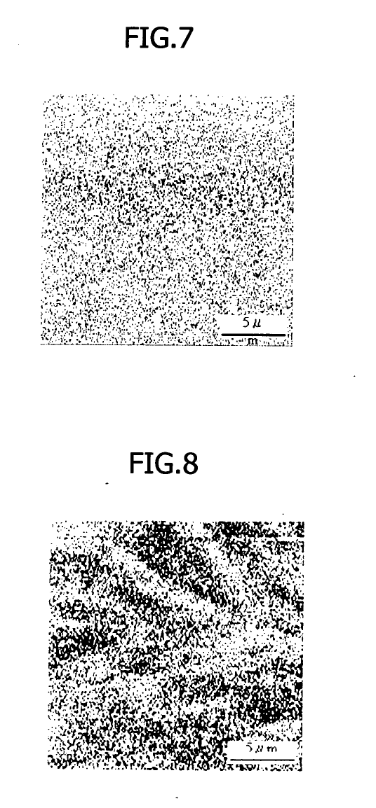

Furthermore, in order to investigate the state of magnetic migration, a Kerr effect image was taken across the entire substrate region with a magnetic sensor device (OSA5100, made by Candela), as shown in FIG. 6, but magnetic migration causing spike noise from the soft magnetic film was not observed. Moreover, when the state of the soft magnetic film surface was examined with an MFM (magnetic force microscope), magnetic domains that may result in white noise were not observed as shown in FIG. 7.

### COMPARATIVE EXAMPLE 1

The substrate which had been obtained in the same manner as in Example 1 was immersed for 10 minutes in a 2 wt % aqueous caustic soda solution at 45° C. so that the thin surface oxide film was removed from the surface of the substrate and then the Si surface was etched.

Then, a primer plating bath (solution) was prepared by adding 0.5 N ammonium sulfate into an aqueous solution of 0.1 N nickel sulfate and the substrate was immersed for 5 minutes in the bath heated to 80° C. so that the primer plating layer was formed.

Furthermore, a plating bath (solution) containing 0.2 N ammonium sulfate, 0.02 N nickel sulfate, 0.1 N cobalt sulfate, 0.01 N iron sulfate, and 0.06 N dimethyl amine borane as a reducing agent was prepared. The bath was heated to 70° C., such that the film growth rate of the electroless plating was 0.3 μm/min. Permanent magnets were arranged in front of and behind the plating bath, and a parallel magnetic field of 450 to 600 oersteds was applied to the substrate during the plating. The substrate to be plated was rotated at a rotation rate of 60 rpm, while electroless plating was performed for 15 min. During this time, the rate of the plating solution at a position 5 mm away from the substrate surface was measured by a laser doppler flow rate meter. The rate was measured to be 100 mm/min with respect to the substrate at a radial position of 20 mm, i.e. at the inner circumference of the substrate. The rate was measured to be 290 mm/min with respect to the substrate at a radial position of 32.5 mm, i.e. at the outer circumference of the substrate. Thus, the ratios of the plating film forming rate to the plating solution flow rate at the substrate surface to be plated were 1/333,333 and 1/966,667, respectively.

When the magnetic characteristics of the soft magnetic film obtained in such a manner were measured using an vibrating sample magnetometer, the circumferential coercive force in the direction parallel to the face of the soft magnetic layer was 31 oersteds, the saturation magnetization was 16 kG, and the residual magnetization was 0.25 kG, so that the ratio of the saturation magnetization to the residual magnetization was 64/1.

Furthermore, when Hₜᵣ and H_{tc} were measured on basis of a VSM magnetization measurement wherein Hₜᵣ is the value of an external magnetic field at the inflection point in the first quadrant of a minor loop of radial direction within the substrate plane and H_{tc} is the value of an external magnetic field at the inflection point in the first quadrant of a minor loop of circumferential direction within the substrate plane (see FIG. 3), Hₜᵣ and H_{tc} were found to be 78 oersteds and 80 oersteds, respectively. Thus, Hₜᵣ/H_{tc} was 0.97.

Furthermore, when Hₜᵥ was measured on basis of a VSM magnetization measurement wherein Hₜᵥ is an external magnetic field at the inflection point in the first quadrant of a minor loop of perpendicular direction (see FIG. 4), Hₜᵥ was found to be 1,600 oersteds. Thus, Hₜᵥ/H_{tc} was 80.

The substrate having this soft magnetic layer was covered with a recording film in the same manner as in Example 1 so that a perpendicular magnetic recording medium was produced.

The resulting medium was installed on a spinstand and DC erasing was carried out. Then, a writing operation was performed with a nanoslider GMR head at a floating height of 10 nm and the reproduction signal was measured. The result of this measurement was that many spike noises were observed in the envelope pattern, as shown in FIG. 5. Also, the average level of the S/N ratio was a poor 10 dB.

Furthermore, in order to investigate the state of magnetic migration, a Kerr effect image was taken across the entire substrate region with a magnetic sensor device (OSA5100, made by Candela). As a result, a large number of localized magnetic walls causing spike noises were observed. Moreover, when the state of the soft magnetic film surface was examined with an MFM (magnetic force microscope), magnetic domains that may result in white noise were observed as shown in FIG. 8.

### COMPARATIVE EXAMPLE 2

The substrate which had been obtained in the same manner as in Example 1 was immersed for 10 minutes in a 2 wt % aqueous caustic soda solution at 45° C. so that the thin surface oxide film was removed from the surface of the substrate and then the Si surface was etched.

Then, a primer plating bath (solution) was prepared by adding 0.5 N ammonium sulfate into an aqueous solution of 0.1 N nickel sulfate and the substrate was immersed for 5 minutes in the bath heated to 80° C. so that the primer plating layer was formed.

Furthermore, a plating bath (solution) containing 0.2 N ammonium sulfate, 0.02 N nickel sulfate, 0.1 N cobalt sulfate, 0.01 N iron sulfate, and 0.015 N dimethyl amine borane as a reducing agent was prepared. The bath was heated to 62° C., such that the film growth rate of the electroless plating was 0.05 μm/min. Permanent magnets were arranged in front of and behind the plating bath, and a parallel magnetic field of 450 to 600 oersteds was applied to the substrate during the plating. The substrate to be plated was rotated at a rotation rate of 60 rpm, while electroless plating was performed for 60 min. The average thickness of the obtained film was 3.0 μm and there were six places mainly on the outer circumference which the places had not been covered with the plated film. During this time, the rate of the plating solution at a position 5 mm away from the substrate surface was measured by a laser doppler flow rate meter. The rate was measured to be 2800 mm/min with respect to the substrate at a radial position of 20 mm, i.e. at the inner circumference of the substrate. The rate was measured to be 8000 mm/min with respect to the substrate at a radial position of 32.5 mm, i.e. at the outer circumference of the substrate. Thus, the ratios of plating film forming rate to plating solution flow rate at the substrate surface to be plated were 1/56,000,000 and 1/160,000,000, respectively.

1. A magnetic recording medium substrate comprising:
a substrate having a diameter of not more than 90 mm and
a soft magnetic film plating layer comprising an alloy that comprises at least two metals selected from the group consisting of Co, Ni and Fe, which is disposed on the substrate,
wherein with respect to a concentric circular direction within a plane of the substrate, a value of the coercive force obtained by a VSM magnetization measurement, is less than 30 oersteds, and a ratio of saturation magnetization to residual magnetization is from 50/1 to 5/1.

2. The magnetic recording medium substrate according to claim 1, having a circumferential magnetic anisotropy such that a value of Hₜᵣ/H_{tc} is from 5 to 1 wherein Hₜᵣ is a value of an external magnetic field at an inflection point in the first quadrant of a minor loop of a radial direction within the substrate plane and H_{tc} is a value of an external magnetic field at an inflection point in the first quadrant of a minor loop of a circumferential direction within the substrate plane, on basis of the VSM magnetization measurement.

3. The magnetic recording medium substrate according to claim 1, having an in-plane magnetic anisotropy such that a valule of Hₜᵥ/H_{tc} is from 10,000 to 100 wherein Hₜᵥ is a value of an external magnetic field at an inflection point in the first quadrant of a minor loop of a perpendicular direction to the substrate plane and H_{tc} is the value of an external magnetic field at the inflection point in the first quadrant of a minor loop of a circumferential direction within the substrate plane, on basis of the VSM magnetization measurement.

4. The magnetic recording medium substrate according to claim 2, having an in-plane magnetic anisotropy such that a value of Hₜᵥ/H_{tc} is from 10,000 to 100 wherein Hₜᵥ is a value of an external magnetic field at an inflection point in the first quadrant of a minor loop of a perpendicular direction to the substrate plane and H_{tc} is the value of an external magnetic field at the inflection point in the first quadrant of a minor loop of a circumferential direction within the substrate plane, on basis of the VSM magnetization measurement.

5. A method for manufacturing a magnetic recording medium substrate comprising:
a step of forming a primer plating layer on a substrate having a diameter of not more than 90 mm by immersing the substrate in a plating solution comprising an metal ion of at least one metal selected from the group consisting of Ag, Co, Cu, Ni, Pd and Pt; and
a step of forming, by electroless plating, a soft magnetic layer on the primer plating layer by immersing the substrate on which the primer plating layer has been formed in a plating solution comprising metal ions of at least two metals selected from the group consisting of Co, Ni and Fe;
wherein in the step of forming the soft magnetic layer by electroless plating, applying a parallel magnetic field of 100 to 800 oersteds in a direction parallel to the plated substrate, the substrate is plated while being rotated and/or revolved so that a ratio of a plating rate at which the film is plated onto the substrate to the plating solution rate at the surface of the substrate to be plated is 1/3,000 or smaller and larger than 1/200,000, under a condition that the plating rate is at least 0.03 μm/min and less than 0.3 μm/min.

6. A magnetic recording medium using said magnetic recording medium substrate according to claim 1.

7. A magnetic recording medium using said magnetic recording medium substrate according to claim 2.

8. A magnetic recording medium using said magnetic recording medium substrate according to claim 3.

9. A magnetic recording medium using said magnetic recording medium substrate according to claim 4.
